(19) United States
(12) Patent Application Publication
(10) Pub. No.: US 2015/0136078 A1
(43) Pub. Date: May 21, 2015

(54) AIRFLOW CONTROL APPARATUS

(71) Applicant: AISIN SEIKI KABUSHIKI KAISHA, Kariya-shi, Aichi (JP)

(72) Inventors: Toshiyuki Oiwa, Handa-shi (JP); Hiromitsu Ishihara, Okazaki-shi (JP)

(21) Appl. No.: 14/412,091

(22) PCT Filed: Jun. 28, 2013
(86) PCT No.: PCT/JP2013/067904

§ 371 Date: Dec. 30, 2014

(30) Foreign Application Priority Data
Jul. 4, 2012 (JP) 2012-150724

(51) Int. Cl. F02D 9/10

(52) U.S. Cl. CPC F02D 9/1005
USPC 123/337

(57) ABSTRACT

An airflow control apparatus does not impede fluid flow and does not reduce intake efficiency even when a flow passage area is decreased by the valve area. The airflow control apparatus includes a housing whose interior forms a fluid passage, bushes attached to the housing interior, a shaft held by the bushes, and a valve attached to the housing interior and rotatable in synchronization with the shaft. The passage includes an upstream passage, a dead band, and a downstream passage. Bush attachment grooves are provided in a portion of the passage. The bottom surface of the bush attachment grooves include an opening. The bushes are rotatably fitted to the opening and are attached to the housing interior. A first cross section perpendicular to a flow direction in the upstream passage has a larger cross-sectional area than a second cross section perpendicular to the flow direction in the downstream passage.

### TECHNICAL FIELD

The present invention relates to an airflow control apparatus that is provided in an intake passage to an engine and controls the flow amount of fluid in the intake passage.

### BACKGROUND ART

An airflow control apparatus that adjusts the flow amount of fluid in an intake passage in accordance with the load state of an engine and the open/closed state of an intake valve may be provided downstream of an intake manifold and upstream of the intake valve. Doing so is expected to achieve an increased engine output due to an increased volumetric efficiency, an improved combustion due to an increased fluid speed, a decreased smoke, and the like, thus improving fuel efficiency, for example. The airflow control apparatus includes a housing including a passage that allows fluid to flow therethrough, and a valve that is rotatably accommodated in the interior of the housing and controls the intake amount of fluid.

FIG. 13 is a perspective view showing a schematic configuration of a conventional airflow control apparatus 101. FIG. 14 is a cross-sectional view of the airflow control apparatus 101, taken along the flow direction of air. The airflow control apparatus 101 includes a housing 110, bushes (not shown), a shaft 140, and a valve 150. The housing 110 has a fluid passage 111 in its interior. A part of the passage 111 is cut out to form bush attachment grooves 114. The bushes are attached to the bush attachment grooves 114, and fluid does not flow through the bush attachment grooves 114. The valve 150 has a shape that blocks half of the passage 111 in the closed state, and is accommodated in the interior of the housing 110. The shaft 140 passes through the bushes, the housing 110, and the valve 150, and rotatably supports the valve 150. The valve 150 rotates in synchronization with the shaft 140, and controls the flow amount of the fluid flowing through the passage 111. As shown in FIG. 14, the passage 111 has an oval cross section both on the upstream side and the downstream side of the valve 150, and the cross-sectional area perpendicular to the flow direction is also constant.

Patent Document 1 discloses an airflow control apparatus including a housing having a flow passage that allows intake air to flow therethrough, and a valve that is rotatably accommodated in the interior of the housing so as to control the amount of intake air. In this airflow control apparatus, opposing surface portions that oppose a circumferential edge portion of a valve when the valve is in the closed state is formed in the flow passage. At least a part of the opposing surface portions along the inner circumferential direction of the flow passage is formed as an inclined surface facing only one direction along the longitudinal direction of the flow passage. The inclined surface is formed in a concave shape conforming to the locus of the circumferential edge portion of the valve.

### PRIOR ART DOCUMENT

### Patent Document

Patent Document 1: JP 2009-127522A

### DISCLOSURE OF THE INVENTION

### Problem to be Solved by the Invention

As shown in FIGS. 13 and 14, in the conventional airflow control apparatus 101, the presence of the shaft 140 and the valve 150 results in a reduction of the flow passage area on the upstream side of the valve 150 even when the valve 150 is in the open state. Accordingly, there has been the problem that the flow of fluid is impeded, and the intake efficiency is reduced.

In view of the above-described problem, it is an object of the present invention to provide an airflow control apparatus that does not impede the flow of fluid even when the flow passage area is reduced by the amount corresponding to the area of the valve, and does not reduce the intake efficiency.

### Means for Solving Problem

In order to solve the above-described problem, according to an aspect of the invention, there is provided an airflow control apparatus including: a tubular housing whose interior forms a passage for fluid; two annular bushes that are attached to the interior of the housing; a shaft that is held by the bush; and a valve that is attached to the interior of the housing and is rotatable in synchronization with the shaft, wherein the passage includes an upstream passage, a dead band that is continuously connected with the upstream passage and in which flow communication with the upstream passage is blocked when the valve is in a predetermined orientation, and a downstream passage disposed opposite to the upstream passage relative to the dead band, bush attachment grooves are cut out in a portion of the passage, the bush attachment grooves being formed by extending recesses to a vicinity of a center of the passage along a flow direction, the recesses being formed outward respectively from opposing two sides on an inner circumference of a first end face that is an end face of the upstream passage, an opening through the housing is formed in a portion of a bottom surface of each of the bush attachment grooves, each of the bushes is rotatably fitted to the opening and is attached to the housing, the shaft passes through and is held by the bushes, while intersecting the dead band, a first cross section perpendicular to the flow direction in the upstream passage has a cross-sectional area larger than a cross-sectional area of a second cross section perpendicular to the flow direction in the downstream passage, the first cross section has a shape including first curved portions, the second cross section has a shape including second curved portions, and the first curved portions have a curvature larger than a curvature of the second curved portions.

With this characteristic configuration, even when the shaft and the valve reside in the passage, the curvature of the first curved portions can be made larger than the curvature of the second curved portions, thus making the cross-sectional area of the first cross section larger than the cross-sectional area of the second cross section. Accordingly, even when the valve is in the open state, it is possible to suppress the reduction in the intake efficiency, without impeding the flow of fluid in the upstream passage.

In the airflow control apparatus according to the present invention, it is preferable that the curvature of the second curved portions continuously increases from a second end face that is an end face of the downstream passage toward the dead band.

With this configuration, a change in the curvature does not cause a resistance that impedes the flow of fluid, and it is thus possible to suppress the reduction in the intake efficiency.

In the airflow control apparatus according to the present invention, it is preferable that the bushes are attached to the housing so as not to protrude from the bush attachment grooves to the passage.

With this configuration, the bushes do not create a resistance that impedes the flow of fluid. Accordingly, it is possible to suppress the reduction in the intake efficiency.

In the airflow control apparatus according to the present invention, it is preferable that the passage in the interior of the housing is formed by combining a first mold and a second mold, the first mold forms the upstream passage, the bush attachment grooves, a portion of the dead band, and a portion of the downstream passage, and the second mold forms a remainder of the downstream passage and a remainder of the dead band.

With this configuration, the passage in the interior of the housing can be molded without the need of a complex mold structure, although molding of the housing as a whole requires a slide core.

### BRIEF DESCRIPTION OF THE DRAWINGS

FIG. 1 is a diagram illustrating an overview of an engine equipped with an airflow control apparatus according to the present embodiment.

FIG. 2 is a cross-sectional view of the airflow control apparatus, taken along the flow direction of air.

FIG. 3 is a cross-sectional view taken along the arrows III-III in FIG. 2.

FIG. 4 is a perspective view showing a schematic structure of the housing.

FIG. 5 is a diagram showing a structure of the housing when viewed from the upstream side along the flow direction of air.

FIG. 6 is a cross-sectional view of the housing, taken along the flow direction of air.

FIG. 7 is a cross-sectional view taken along the arrows VII-VII in FIG. 6.

FIG. 8 is a cross-sectional view taken along the arrows VIII-VIII in FIG. 6.

FIG. 9 is a cross-sectional view taken along the arrows IX-IX in FIG. 6.

FIG. 10 is a diagram illustrating a state in which molds for molding the housing are closed.

FIG. 11 is a diagram illustrating a state in which the molds for molding the housing are opened.

FIG. 12 is a cross-sectional view taken along the arrows XII-XII in FIG. 11.

FIG. 13 is a perspective view illustrating a schematic structure of a conventional airflow control apparatus.

FIG. 14 is a cross-sectional view of the conventional airflow control apparatus, taken along the flow direction of air.

### BEST MODE FOR CARRYING OUT THE INVENTION

### 1. Configuration of Airflow Control Apparatus

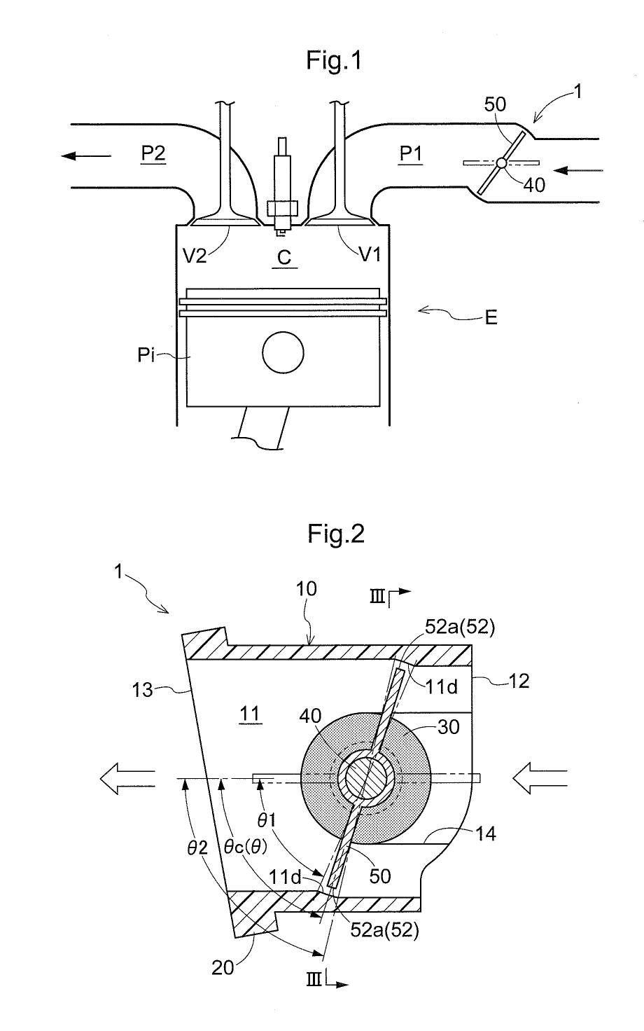

In the following, an embodiment of the present invention will be described in detail. FIG. 1 is a diagram illustrating an engine E equipped with an airflow control apparatus 1 according to the present embodiment. The airflow control apparatus 1 is provided in an intake passage P1 through which air traveling from an intake manifold (not shown) to the engine E. Air is an example of fluid flows. Air is introduced to a combustion chamber C from the intake passage P1 as a result of an intake valve V1 being opened as a piston Pi of the engine E moves downward. Exhaust gas resulting from the combustion in the combustion chamber C flows through an exhaust passage P2 via an exhaust valve V2. The exhaust gas is recirculated as needed, but is eventually discharged to the outside of the engine E. The airflow control apparatus 1 controls the amount of the air taken into the combustion chamber C by changing the cross-sectional area perpendicular to the flow direction of air in the intake passage P1 (hereinafter, may be simply referred to as “flow direction”).

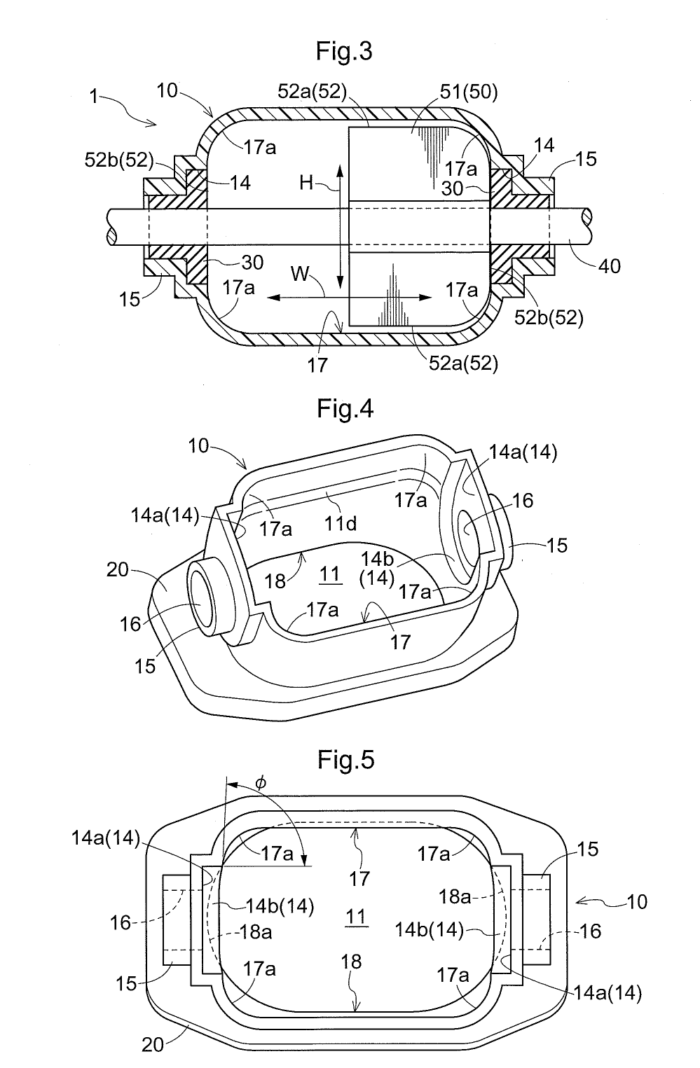

FIG. 2 is a cross-sectional view of the airflow control apparatus 1, taken along the flow direction. FIG. 3 is a cross-sectional view taken along the arrows III-III in FIG. 2. The airflow control apparatus 1 includes a housing 10 whose interior forms a passage 11 for air, two annular bushes 30 that are attached to the interior of the housing 10, a shaft 40 that is held by the bushes 30, a valve 50 that is attached to the interior of the housing 10 and is rotatable in synchronization with the shaft 40. The shaft 40 passes through the bushes 30, the housing 10, and the valve 50. The open arrows shown in FIG. 2 indicate the flow direction of air.

As shown in FIGS. 2 and 3, the shaft 40 is, for example, a rod-shaped member having a circular cross section. The shaft 40 is inserted through the valve 50, and supports the valve 50 so as to rotate the valve 50 in synchronization therewith. The shaft 40 is configured such that a single shaft 40 passes through a plurality of valves 50 of the airflow control apparatuses 1 that are arranged in a line. For example, when the engine E is an inline four-cylinder engine, a single shaft 40 passes through four valves 50. One end of the shaft 40 is connected to an actuator (not shown). The rotation of the actuator is controlled by an ECU (not shown) that controls the flow amount of air based on the load of the engine E, the state of the intake valve V1, and the like. As the actuator is driven, the shaft 40 is rotated, and the valve 50 is rotated in synchronization therewith.

The valve 50 is a thin plate-shaped member having a uniform thickness and being disposed in the interior of the housing 10, and is supported by the shaft 40 so as to be rotatable relative to the housing 10. As shown in FIG. 2, the cross-sectional area of the passage 11 is changed by rotation of the valve 50. As shown in FIG. 3, the valve 50 resides in only half of the passage 11. A pressure-receiving surface 51, which is the surface of the valve 50 as viewed in the thickness direction, has a rectangular shape that is curved at two corner portions near the inner circumference edge of the passage 11. Of circumferential edge surfaces 52 constituting the thickness of the valve 50, a lateral circumferential edge surface 52a parallel to the shaft 40 is curved in the shape of a circular arc around the shaft 40, and a longitudinal circumferential edge surface 52b perpendicular to the shaft 40 is flat.

As shown in FIG. 2, the position (indicated by the dashed double-dotted line) at which valve 50 is parallel to the flow direction is a reference position. When the valve 50 is at the reference position, the passage 11 is in the open state. The angle by which the valve 50 is rotated from the reference position around the shaft 40 is represented by θ. That is, the angle θ is 0 degrees when the valve 50 is at the reference position. When the valve 50 is rotated from the reference position by a predetermined angle θc, the passage 11 is placed in the closed state in which half of the passage 11 is blocked by the valve 50. In the closed state, the gap between the circumferential edge surfaces 52 and the passage 11 is very small, and the flow amount of air is reduced to about half of that in the open state.

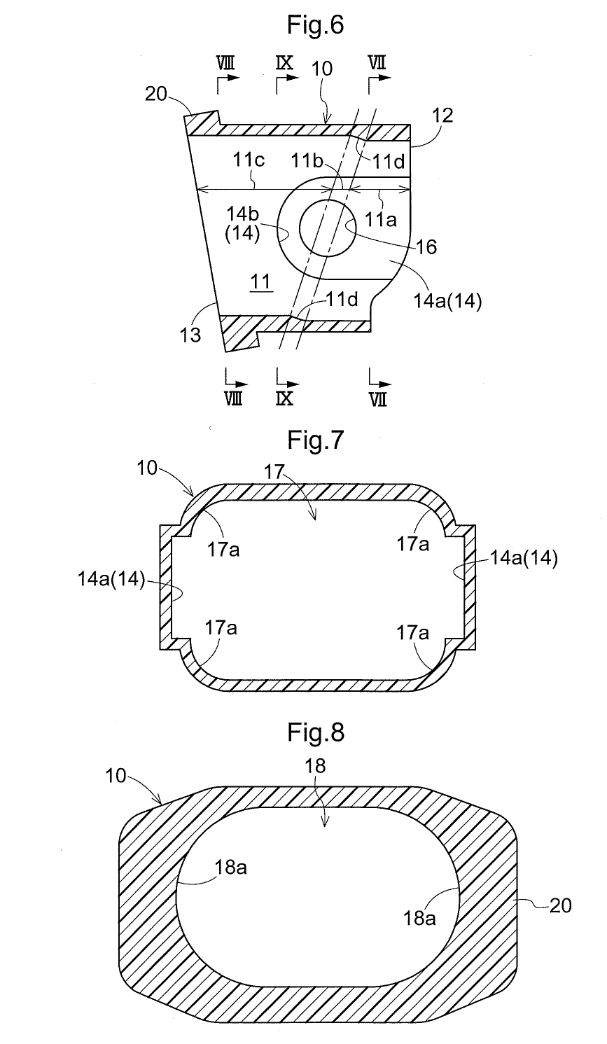

FIG. 4 is a perspective view showing a schematic structure of the housing 10. FIG. 5 is a diagram showing the structure of the housing 10 as viewed from the upstream side along the flow direction. FIG. 6 is a cross-sectional view of the housing 10, taken along the flow direction. As shown in FIGS. 4 and 6, the housing 10 has a tubular shape having a hollow interior, and includes, at its downstream end, a flange 20 having an octagonal shape whose corner portions are curved. The hollow portion forms the passage 11.

As shown in FIG. 6, the passage 11 includes an upstream passage 11 a connected with the intake manifold, a dead band 11b that is continuously formed from the upstream passage 11a, and a downstream passage 11c that is continuously formed from the dead band 11b and is connected with the intake passage P1 connecting with the combustion chamber C. FIG. 7 is a cross-sectional view taken along the arrows VII-VII in FIG. 6. As shown in FIG. 7, a first cross section 17 that is perpendicular to the flow direction in the upstream passage 11a has a rectangular shape having first curved portions 17a constituted by curved corner portions. The shape of the first cross section 17 is constant in the flow direction. Note that the first cross section 17 does not include bush attachment grooves 14, which will be described later.

As shown in FIGS. 2 and 6, the dead band 11b is provided at a position at which the valve 50 places the passage 11 in the closed state, or in other words, a position opposing the circumferential edge surfaces 52 of the valve 50 when the rotation angle of the valve 50 is θc. The two surfaces in the height direction (the H direction in FIG. 3) in the dead band 11b that oppose the lateral circumferential edge surface 52a have an inclined surface 11d that is inclined in one direction with respect to the flow direction of the upstream passage 11a. The inclined surface 11d is formed into a curved surface having a circular arc shape around the attached shaft 40. Consequently, the gap between the inclined surface 11d and the lateral circumferential edge surface 52a is maintained substantially constant in a state in which the valve 50 is attached.

Additionally, the length of the inclined surface 11d in the flow direction is larger than the thickness of the valve 50. Consequently, the angle θc at which the closed state is achieved is not a single angle, but has the range “θ1≦θc≦θ2” shown in FIG. 2. With this configuration, it is not necessary to finely control the rotation angle of the valve 50 in order to achieve the closed state. Note that the two surfaces opposing in the width direction (the W direction in FIG. 3) in the dead band 11b are on the same plane as the two surfaces opposing in the W direction in the upstream passage 11a, and have a very small gap between the longitudinal circumferential edge surface 52b and themselves.

The downstream passage 11c extends from an end of the dead band 11b that is opposite to the upstream passage 11a such that its flow direction extends parallel to the upstream passage 11a, and its length in the H direction is the same as that of the upstream passage 11a and its length in the W direction is longer than that of the upstream passage 11a. That is, as shown in FIGS. 5 and 6, the upstream passage 11a and the downstream passage 11c are offset in the H direction, but not offset in the W direction.

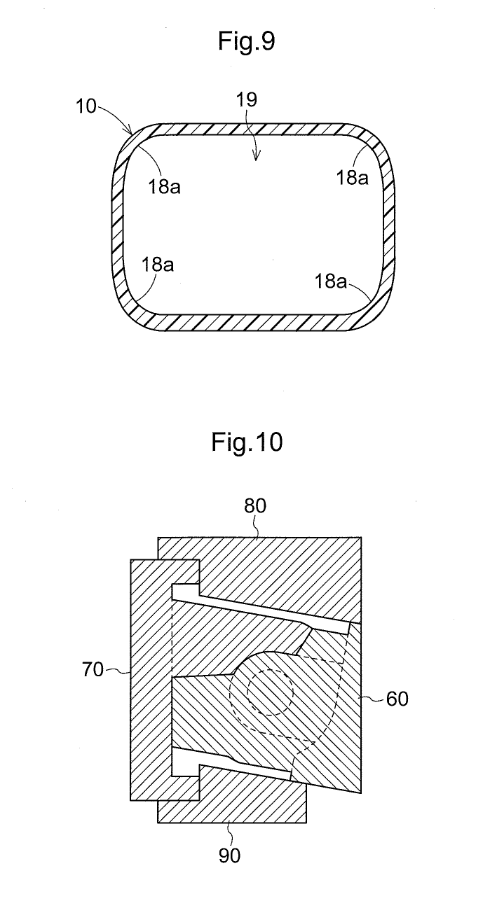

FIG. 8 is a cross-sectional view taken along the arrows VIII-VIII in FIG. 6. FIG. 9 is a cross-sectional view taken along the arrows IX-IX in FIG. 6. As shown in FIG. 8, a second cross section 18 perpendicular to the flow direction on the downstream side (the left side in FIG. 6) of the downstream passage 11c has a rectangular shape (including, an oval shape) having second curved portions 18a constituted by curved corner portions. The curvature of the second curved portions 18a continuously changes so as to increase toward the direction of the dead band 11b. As shown in FIG. 9, a third cross section 19, which is the cross section near a location intersecting the dashed dotted line indicating the boundary between the dead band 11b and the downstream passage 11c, has substantially the same shape as that of the first cross section 17. As the cross-sectional shape changes from the second cross section 18 to the third cross section 19 due to the changing curvature of the second curved portion 18a, the cross-sectional area (the area of the internal space) gradually increases. To summarize, the cross-sectional area perpendicular to the flow direction of the passage 11 of the housing 10 is configured to decrease from upstream toward downstream in the flow direction, or in other words, in the order of the first cross section 17, the third cross section 19, and the second cross section 18.

As shown in FIG. 5, the difference between the cross-sectional area (the area of the internal space) of the first cross section 17 (the front most rectangular space) and that of the second cross section 18 (the oblong space that is located at the back and is partly indicated by the broken line) is larger than the area by which the shaft 40 and the valve 50 in the open state overlap the passage 11 when viewed along the flow direction of air. This can be achieved by making the curvature of the first curved portion 17a larger than the curvature of the second curved portion 18a. Consequently, even when the shaft 40 and the valve 50 reside in the passage 11 during the open state of the valve 50, the cross-sectional area of the portion through which the air flows is not decreased. Accordingly, air can be smoothly flowed from the upstream passage 11a toward the downstream passage 11c. Note that, as shown in FIGS. 2 and 6, a second end face 13 that is an end portion of the downstream passage 11c is inclined relative to the flow direction.

As shown in FIGS. 4 and 5, recesses 14a having a predetermined width are formed outward from opposite sides, in the W direction, on the inner circumference of a first end face 12 that is an end portion of the upstream passage 11a. Bush attachment grooves 14 are formed by extending the recesses 14a from the first end face 12 to the vicinity of the center along the flow direction. The innermost portion of each bush attachment groove 14 forms a semicircular portion 14b conforming to the outer shape of the bush 30. Also, columnar protruding portions 15 are formed on opposite outer sides of the housing 10, coaxially with the center of the semicircular portions 14b. A circular opening 16 coaxial with the center of the semicircular portions 14b is formed through the housing 10 and the protruding portions 15 from the bottom surface of the bush attachment grooves 14.

As shown in FIG. 5, the angle φ formed between a side wall of the bush attachment groove 14 and the first curved portion 17a is approximately 85 degrees. The angle φ is preferably 60 degrees or more. Even when the bush attachment groove 14 is provided, it is possible to ensure a sufficient strength for a mold that is used to form the housing 10 by injection molding by increasing the angle φ by increasing the curvature of the first curved portion 17a in this way. The details of the method for molding the housing 10 will be described later.

In the present embodiment, each bush 30 has a shape in which two annular concentric rings having different outer diameters and the same inner diameter are stacked in stages, as shown in FIG. 3. The annular ring having a smaller outer diameter is fitted to the opening 16, and the annular ring having a larger outer diameter is fitted to the semicircular portion 14b of the bush attachment groove 14. The axial thickness of the annular ring having a larger outer diameter is less than or equal to the depth of the bush attachment groove 14, and the bush 30 does not protrude from the top surface of the bush attachment groove 14 to the upstream passage 11a side. Accordingly, the bush 30 does not create a resistance to the air flowing through the passage 11. The bush 30 is rotatably fitted and fixed to the housing 10. The shaft 40 is inserted through the inner diameter space of the bush 30 without any gap, and the bush 30 holds the shaft 40.

In the present embodiment, the bush 30 is configured not to protrude from the top surface of the bush attachment groove 14 to the upstream passage 11a side. However, the present invention is not limited to this configuration. It is possible to adopt a configuration in which the bush 30 protrudes from the top surface of the bush attachment groove 14 to the upstream passage 11a side although there will be some increase in the resistance to the air flowing through the passage 11. In the present embodiment, the valve 50 has a shape that blocks half of the passage 11 in the closed state. However, the present invention is not limited to this shape. For example, the valve 50 may take any shape according to the specification of the flow amount of air in the closed state, including, for example, a shape that blocks the whole of the passage 11 in the closed state.

In the present embodiment, the first cross section 17 and the second cross section 18 have a rectangular shape and an oblong shape whose corner portions have a constant curvature. However, the present invention is not limited thereto. The first cross section 17 and/or second cross section 18 may be an elliptical shape or a different shape, including, for example, a shape in which a longer side and a shorter side are smoothly connected by curved lines having a changing curvature.

### 2. Method for Manufacturing Housing

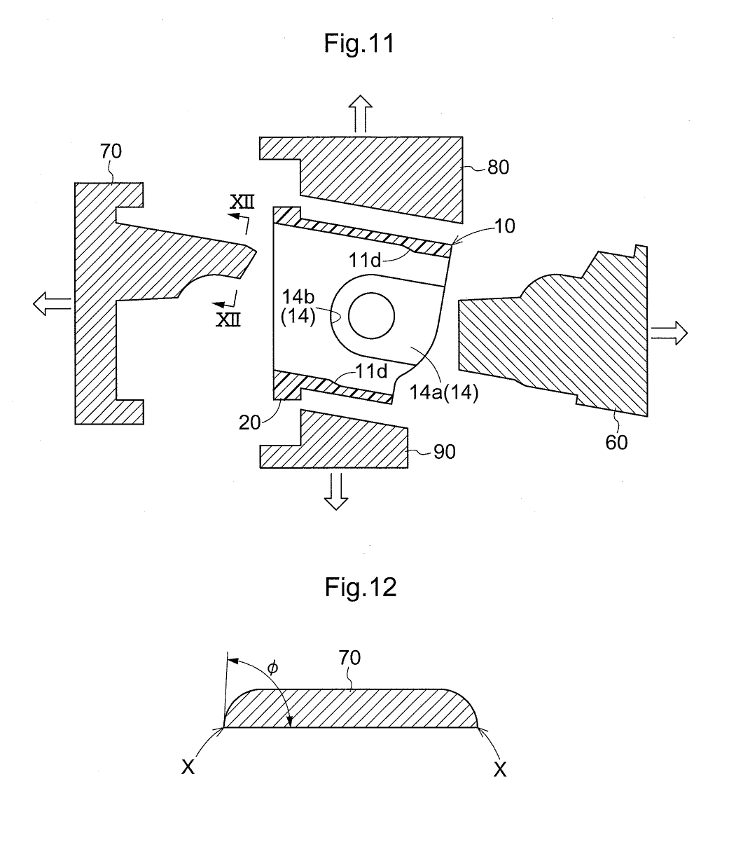

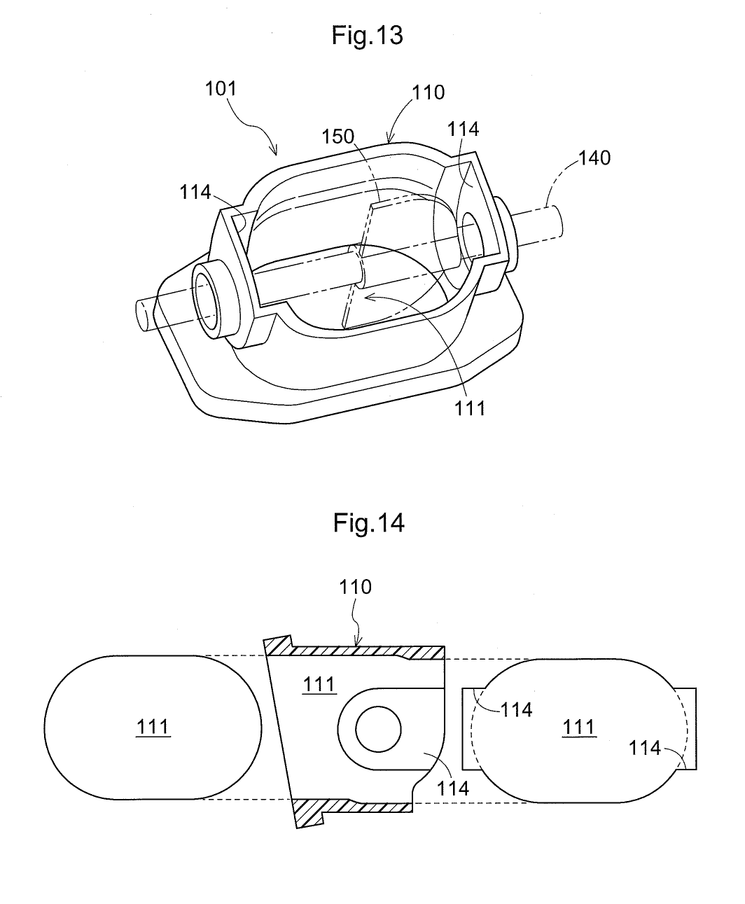

Next, a method for manufacturing the housing 10 of the airflow control apparatus 1 according to the present embodiment will be described with reference to the drawings. FIG. 10 is a diagram illustrating a state in which molds for molding the housing 10 are closed. FIG. 11 is a diagram illustrating a state in which the molds for molding the housing 10 are opened. FIG. 12 is a cross-sectional view taken along the arrows XII-XII in FIG. 11.

The housing 10 is formed by injection-molding a synthetic resin such as a polyamide resin. In FIG. 10, a first mold 60 and a second mold 70 that form the passage 11 of the housing 10 and a third mold 80 and a fourth mold 90 that form the outer shape of the housing 10 are set in a closed state. Although not shown in FIGS. 10 and 11, in addition to these four types of molds, a mold that moves in a direction perpendicular to the direction of movement of the four types of molds is required in order to actually mold the housing 10. The protruding portions 15 and the opening 16 are formed by this mold.

With the first mold 60, the upstream passage 11a, the bush attachment groove 14, a portion of the dead band 11b that is located below the bush attachment groove 14, and the lower half of the downstream passage 11c are formed. With the second mold 70, the upper half of the downstream passage 11c and a portion of the dead band 11b that is located above the bush attachment groove 14 are formed.

As shown in FIG. 11, a portion of the second mold 70 that is above the bush attachment groove 14 and at which the dead band 11b is formed has a smaller thickness than the other portions of the second mold 70. Therefore, if molding is repeatedly performed using a mold in which the angle φ shown in FIG. 12 is small (less than 60 degrees), curved corner portions X may be cracked or chipped. However, as shown in FIG. 5, with the housing 10 according to the present embodiment, the curvature of the first curved portion 17a is made large so that the angle φ formed by the side wall of the bush attachment groove 14 and the first curved portion 17a is approximately 85 degrees. Accordingly, as shown in FIG. 12, the angle φ of the curved corner portions X of the second mold 70 for molding the corresponding location of the housing 10 is also approximately 85 degrees. This enables a sufficient strength to be ensured at the curved corner portions X, thus making it possible to prevent cracking and chipping of the second mold 70.

The present invention can be used for an airflow control apparatus that is provided in an intake passage of an engine and controls the flow amount of fluid in the intake passage.

### DESCRIPTION OF REFERENCE SIGNS

1: Airflow control apparatus

10: Housing

11: Passage

11a: Upstream passage

11b: Dead band

11c: Downstream passage

12: First end face

13: Second end face

14: Bush attachment groove

14a: Recess

16: Opening

17: First cross section

17a: First curved portion

18: Second cross section

18a: Second curved portion

30: Bush

40: Shaft

50: Valve

60: First mold

70: Second mold

1. An airflow control apparatus comprising:
a tubular housing whose interior forms a passage for fluid;
two annular bushes that are attached to the interior of the housing;
a shaft that is held by the bush; and
a valve that is attached to the interior of the housing and is rotatable in synchronization with the shaft,
wherein the passage includes an upstream passage, a dead band that is continuously connected with the upstream passage and in which flow communication with the upstream passage is blocked when the valve is in a predetermined orientation, and a downstream passage disposed opposite to the upstream passage relative to the dead band,
bush attachment grooves are cut out in a portion of the passage, the bush attachment grooves being formed by extending recesses to a vicinity of a center of the passage along a flow direction, the recesses being formed outward respectively from opposing two sides on an inner circumference of a first end face that is an end face of the upstream passage,
an opening through the housing is formed in a portion of a bottom surface of each of the bush attachment grooves,
each of the bushes is rotatably fitted to the opening and is attached to the housing,
the shaft passes through and is held by the bushes, while intersecting the dead band,
a first cross section perpendicular to the flow direction in the upstream passage has a cross-sectional area larger than a cross-sectional area of a second cross section perpendicular to the flow direction in the downstream passage,
the first cross section has a shape including first curved portions,
the second cross section has a shape including second curved portions, and
the first curved portions have a curvature larger than a curvature of the second curved portions.

2. The airflow control apparatus according to claim 1, wherein the curvature of the second curved portions continuously increases from a second end face that is an end face of the downstream passage toward the dead band.

3. The airflow control apparatus according to claim 1, wherein the bushes are attached to the housing so as not to protrude from the bush attachment grooves to the passage.

4. The airflow control apparatus according to claim 1, wherein the passage in the interior of the housing is formed by combining a first mold and a second mold, the first mold forms the upstream passage, the bush attachment grooves, a portion of the dead band, and a portion of the downstream passage, and the second mold forms a remainder of the downstream passage and a remainder of the dead band.
